(19) United States
(12) Patent Application Publication
(10) Pub. No.: US 2026/0363438 A1
(43) Pub. Date: Nov. 19, 2026

(54) DOMESTIC APPLIANCE AND PULL-OUT GUIDE FOR A DOMESTIC APPLIANCE

(71) Applicant: PAUL HETTICH GMBH & CO. KG, Kirchlengern (DE)

(72) Inventors: Andreas LÖH, Bückeburg (DE); Johann-Sebastian LEßMANN, Löhne (DE); Thomas BECKMANN, Paderborn-Sande (DE)

(21) Appl. No.: 19/148,365

(22) PCT Filed: Jan. 16, 2024
(86) PCT No.: PCT/EP2024/050916

§ 371 Date: Jul. 16, 2025

(30) Foreign Application Priority Data
Jan. 17, 2023 (DE) 10 2023 101 024.7

(51) Int. Cl. A47B 88/483; F24C 15/16; H05B 6/64

(52) U.S. Cl. CPC A47B 88/483; F24C 15/168; H05B 6/6408

(57) ABSTRACT

A pull-out guide for a domestic appliance with a microwave cooking function includes a body rail and at least one running rail moveable relative to the body rail and for depositing a cooking product carrier. The body rail and/or the running rail has a U-shaped profile with a base and two limbs. The limbs are electrically connected together by a contact element in an end region of the body rail and/or the running rail, and the contact element is arranged at a distance to the base.

### BACKGROUND AND SUMMARY OF THE INVENTION

Exemplary embodiments of the invention relate to a pull-out guide for a domestic appliance with a microwave cooking function, which has a body rail and at least one running rail moveable relative thereto for depositing a cooking product carrier, wherein the body rail and/or the running rail have a U-shaped profile with a base and two limbs. The invention also relates to a domestic appliance with microwave cooking function with such a pull-out guide.

Pull-out guides have become established in various types of domestic appliances, on which removable carriers, for example cooking product carriers such as cooking trays or grids, can be placed, which can be conveniently inserted into the domestic appliance or extended and removed more easily using the pull-out guide.

Pull-out guides in which the body rail and/or running rail have a U-shaped profile have proven to be advantageous in that they enable a compact design and are well protected against the ingress of dirt by the U-shaped profile. The U-shaped profile is usually punched and bent from a sheet metal material.

In order to prevent sharp edges at the front end of the running rail from posing a risk of injury, and also for visual reasons, it is known to close the front end of the U-shaped profile of the running rail. This can be done over the entire surface using a welded-on plate or by means of an inserted plug. The plate or part of the plug often protrudes upwards over the support surface of the running rail in order to form a support for a placed cooking product carrier and thus prevent the cooking product carrier from slipping off the running rail when it is removed from a cooking chamber. A rear end of a U-shaped body rail usually remains open.

When using a metallic running rail or body rail with a U-shaped profile in a microwave cooking chamber, it has been shown that when the front and/or rear end of the rail is open, the temperature of metallic elements located in a volume surrounded by the U-shaped profile increases compared to the surrounding area, thus also reducing the efficiency in the microwave oven. A similar behavior is observed when the profile rails are closed with a plug made of an electrically insulating material.

Exemplary embodiments of the present invention are directed to a pull-out guide for a domestic appliance with microwave cooking function and a domestic appliance equipped therewith, in which an increase in temperature of elements in the volume enclosed by the respective rail is prevented or at least reduced as far as possible even when the end of a U-shaped running rail and/or body rail is open or closed by an electrically insulating material.

A pull-out guide of the type mentioned at the beginning of the invention is characterized in that the limbs are electrically connected to one another by a contact element in an end region of the body rail and/or the running rail, wherein the contact element is arranged at a distance from the base.

It has been shown that microwaves no longer penetrate the front opening of the profile of the running or body rail if the free ends of the limbs are electrically connected to each other. The connection creates a ring-shaped closed conductive structure consisting of the base of the rail, the limbs, and the contact element, which reflects microwaves. The remaining open area—i.e., the opening of the ring-shaped structure-is small enough for microwaves to penetrate deeper into the volume enclosed by the respective rail, given the usual height or width of the rails of a pull-out guide, which is in the range of a few millimeters to about one centimeter. Unnecessary and undesirable heating, e.g., of the rolling element cage of the pull-out guide, is reduced or avoided, wherein even the arrangement of a contact element in the area of one of the two end faces results in a significant reduction in the temperature increase. Full-surface shielding of the entire opening area is not necessary, which saves material and also makes it possible to cover the end face of the rail-apart from the area of the contact element—in another way, e.g., with an insulating plug.

It is noted that the “U-shape” of the body or running rail within the meaning of the application includes any shape in which two lateral limbs are arranged at a distance from each other on a base. The two limbs can have the same or different lengths and be at the same angles, in particular right angles, to the base or at different angles. In addition, each of the limbs can be straight, angled or curved, particularly in the area of its free end. A trapezoidal shape or a C-shape therefore also falls under the term “U-shaped” in the context of the application.

In an advantageous design of the pull-out guide, the body rail and/or the running rail are made of metal. Another advantage is that the contact element is made of a metal sheet or wire. Due to its high electrical conductivity, this provides good shielding for the microwaves.

In a further advantageous design of the pull-out guide, the contact element is U-shaped and has a base and two lateral limbs. A contact element shaped in this way can be easily inserted into the body or running rail, wherein the limbs of the contact element preferably make contact with the limbs of the body rail or running rail on the inside and the bases facing each other.

In one design, recesses can be arranged in the limbs of the body rail and/or the running rail, into which the contact element engages in a latching manner. For this purpose, the contact element preferably has outwardly projecting latching tabs at the free ends of its limbs, with which it engages in the recesses. The U-shaped geometry of the contact element achieves a spring effect, which on the one hand provides the latching mechanical fastening of the contact element and on the other hand achieves good electrical contact.

Alternatively or additionally, the contact element can be welded to the limbs of the body rail and/or the running rail. A U-shape of the contact element is also advantageous for this, in which the limbs of the contact element lie as flat as possible against the limbs of the rail. Welding can then preferably be carried out using a spot welding process.

In a further advantageous design of the pull-out guide, a plug is inserted into a front end of the running rail and/or a rear end of the body rail, wherein the contact element is arranged on or in the plug. The plug covers the end faces of the body and/or running rails, which protects against injuries on edges of the rail that might otherwise be sharp. In addition, the plug can be made of an electrically insulating material, which provides effective protection against flashovers from the running rail to the front of the microwave oven. Further advantages arise if the material of the plug is also thermally insulating and/or shock-absorbing. In this design, the plug is also used to accommodate the contact element. When the plug is inserted into the rail, the limbs of the U-shaped profile are also contacted in a single work step.

In one design, the plug has an insertion body fastened to the running rail and/or the body rail in a clamping and/or latching manner, wherein the contact element is arranged on and/or at least partially in the insertion body. Preferably, there is at least one recess on the insertion body, which at least partially accommodates the contact element in order to fix it to the plug and to be able to slide the unit comprising plug and contact element into the rail.

The electrically insulating materials listed below can be used for the plug: Ceramics, high-temperature-resistant thermoplastics, in particular from the polyether ketone family (e.g., polyether ether ketone—PEEK), and/or elastomers, in particular from the polysiloxane or thermoset family.

A domestic appliance with microwave cooking function according to the invention is characterized in that it has at least one such pull-out guide. This results in the advantages mentioned in connection with the pull-out guide.

### BRIEF DESCRIPTION OF THE DRAWING FIGURES

The invention is explained in more detail below with reference to exemplary embodiments with the aid of figures, wherein:

FIG. 1a shows a spatial representation of a pull-out guide with rear stop element and a dismantled front contact element in a first exemplary embodiment;

FIG. 1b shows the pull-out guide of FIG. 1a with mounted contact element;

FIG. 2a shows a spatial representation of a pull-out guide with rear stop element and dismantled front and rear contact element in a second exemplary embodiment;

FIGS. 2b, c show the pull-out guide in FIG. 2a with mounted contact elements in two different sliding positions;

FIG. 3 shows a detailed spatial representation of the contact element of FIGS. 1a-2c;

FIGS. 4a, b show representations of a front section of the running rail of the pull-out guide of FIGS. 1a-2c with the contact element removed (FIG. 4a) or inserted (FIG. 4b);

FIG. 5a shows a spatial representation of a pull-out guide with rear stop element and dismantled front and rear contact element in a third exemplary embodiment;

FIGS. 5b, c show the pull-out guide in FIG. 5a with mounted contact elements in two different sliding positions;

FIG. 6 shows a detailed spatial representation of the contact element of FIGS. 5a-c;

FIGS. 7a, b show representations of a front section of the running rail of the pull-out guide of FIGS. 5a-c with the contact element removed (FIG. 7a) or inserted (FIG. 7b);

FIG. 8a shows a spatial representation of a pull-out guide with rear stop element and dismantled front and rear contact element in a fourth exemplary embodiment;

FIGS. 8b, c show the pull-out guide in FIG. 8a with mounted contact elements in two different sliding positions;

FIG. 9 shows a detailed spatial representation of the contact element of FIGS. 8a-c;

FIGS. 10a, b show representations of a front section of the running rail of the pull-out guide of FIGS. 8a-c with dismantled (FIG. 10a) or mounted (FIG. 10b) contact element;

FIGS. 11a-c show representations of a front section of a pull-out guide in a further exemplary embodiment with the plug removed (FIGS. 11a, b) or inserted (FIG. 11c);

FIGS. 12a, b show a representation analogous to FIGS. 11b and 11c from a different angle;

FIGS. 13a, b show representations of a front section of a pull-out guide in a further exemplary embodiment with the plug removed (FIG. 13a) or inserted (FIG. 13b);

FIGS. 14a-c show different representations of the plug (FIGS. 14a, b) or the running rail in sectional view with inserted plug (FIG. 14c) according to FIGS. 13a, b;

FIGS. 15a, b show representations of a front section of a pull-out guide in a further exemplary embodiment with the plug removed (FIG. 15a) or inserted (FIG. 15b); and

FIGS. 16a-c show different representations of the plug (FIGS. 16a, b) or the running rail in sectional view with inserted plug (FIG. 16c) according to FIGS. 15a, b.

### DETAILED DESCRIPTION

In all figures, the same reference signs indicate elements that are identical or have the same effect. For reasons of clarity, not all elements are marked with reference signs in all figures. If relative terms such as “left” or “right” are used in the description, these refer to the figures described. Only the terms “front”, “rear”, “top” and “bottom” refer to the natural orientation of the pull-out rail in operation, in which a cooking product carrier rests on top of the pull-out rail and in which the front end of the pull-out rail points towards a user located in front of the domestic appliance in which the pull-out guide is used.

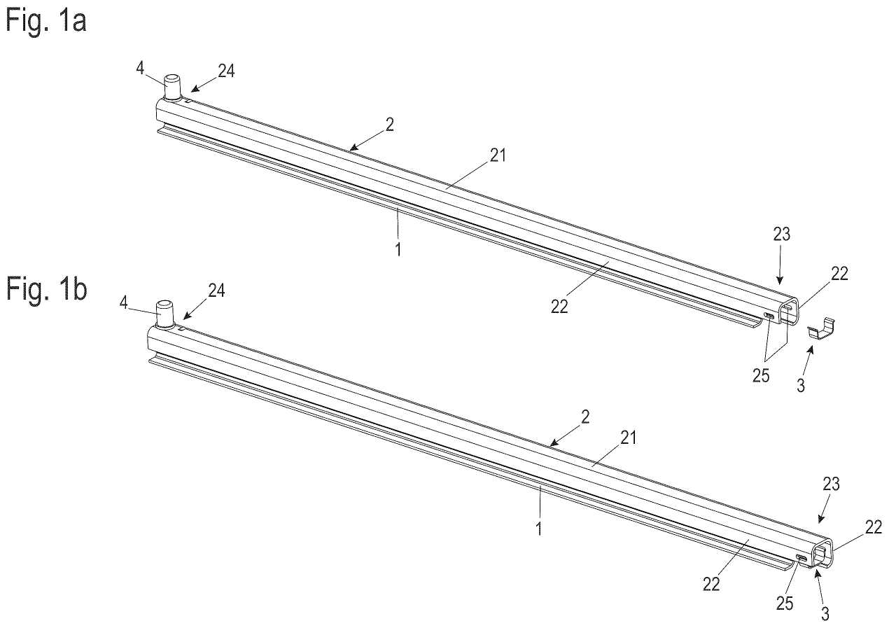

FIGS. 1a, b show a first exemplary embodiment of a pull-out guide according to the application.

The pull-out guide has a fixed body rail 1 that can be fixed in or on a domestic appliance using mounting elements not shown here, such as mounting clips. The pull-out guide is suitable for a microwave oven. The pull-out guide can, for example, be mounted on a side grid, which is typically located in the cooking chamber of the cooking appliance.

A cooking product carrier, e.g., a baking tray or a rack, can be placed on top and moved out of or into the cooking chamber using the pull-out guide.

The pull-out guide comprises a running rail 2, which is mounted so that it can move relative to the body rail 1. In the example shown, the body rail 1, running rail 2 and mounting elements are made of metal, e.g., punched and bent sheet metal.

The running rail 2 is U-shaped and has an upward-facing base 21 and two lateral limbs 22. It has a front end section 23 (in the pull-out direction) and an opposite rear end section 24. A stop 4, in the form of a cylindrical bolt, is attached to the base 21 of the running rail 2 in the rear end section 24. The stop 4 prevents a cooking product carrier resting on it from slipping backwards. In addition, a damping cap can be attached to the pin, which dampens the impact of an edge of the cooking product carrier on the pin.

An arrangement of rolling elements, which is not visible here, is located between the body rail 1 and the running rail 2, allowing the running rail 2 to move easily in relation to the body rail 1. Further components, such as additional running rails or center rails, can also be arranged between the body rail 1 and the running rail 2 to enable an extension.

Two recesses 25 are made in the material of the running rail 2 in the front end section 23 of the running rail 2. A contact element 3 is inserted into these recesses 25. In FIG. 1a, the contact element 3 is shown separately in a disassembled state before insertion; FIG. 1b then shows the pull-out guide with the contact element 3 inserted.

The contact element 3 is made of an electrically conductive sheet metal and connects the limbs 22 of the U-shaped running rail 2 in their front end section 23 in an electrically conductive manner.

This is based on the realization that microwaves can no longer penetrate the U-shaped running rail 2 from the front if the free ends of the limbs 22 are electrically connected to each other. The connection creates a ring-shaped closed conductive structure consisting of base 21, limbs 22, and contact element 3, which reflects microwaves. The remaining open area—i.e., the opening of the ring-shaped structure—is small enough for microwaves to penetrate deeper into the volume enclosed by the running rail 2, given the usual height or width of the running rail 2, which is in the range of a few millimeters to about one centimeter. Unnecessary and undesirable heating, e.g., of the rolling element cage of the pull-out guide, is avoided or significantly reduced. This effect is already significant, even if only one of the two end faces is provided with a contact element of the type mentioned.

A contact element positioned as close to the edge as possible, both in the pull-out direction and in the direction of the free ends of the limbs 22 of the U-shaped running rail 2, has proven to be particularly effective.

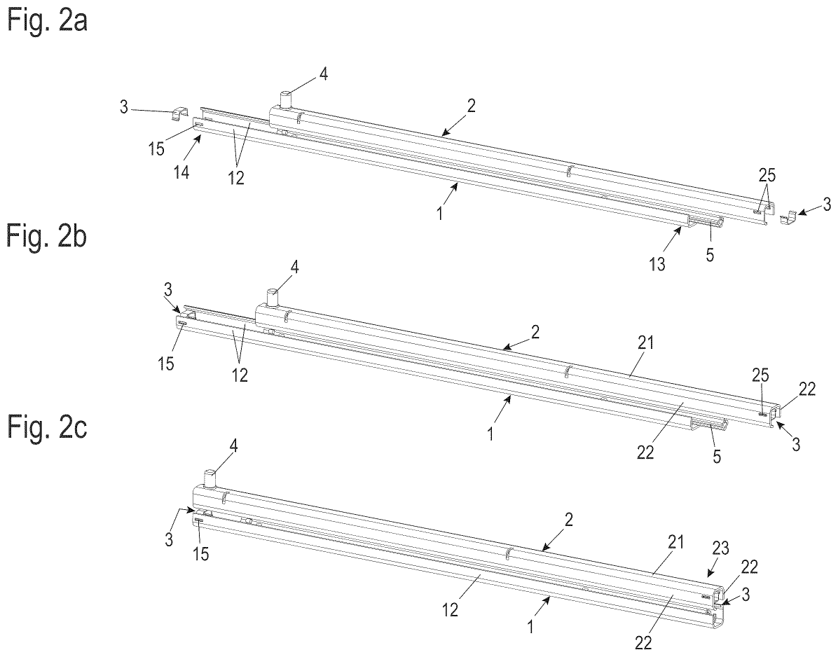

FIGS. 2a-c show a further exemplary embodiment of a pull-out guide according to the application. In contrast to the first exemplary embodiment, a so-called full-extension running rail is shown, wherein the pull-out guide also has a center rail 5 in addition to the body rail 1 and running rail 2.

The structure of the running rail 2 in this second exemplary embodiment is basically comparable to that of the first exemplary embodiment. In this case, the body rail 1 is also U-shaped and has a base 11 and lateral limbs 12. It has a front end section 13 and a rear end section 14. Analogous to the recesses 25 in the front end section 23 of the running rail 2, recesses 15 are made in the limbs 12 in the rear end section 14 of the body rail 1.

In this exemplary embodiment, one contact element 3 is inserted into the running rail 2 and one into the body rail 1, in each case into the corresponding recesses 25 and 15 respectively. This prevents microwaves from penetrating not only from the front into the inner volume enclosed by the running rail 2, but also from the rear into the inner volume enclosed by the body rail 1. In FIG. 2a, the contact elements 3 are shown separately in a disassembled state before insertion; FIGS. 2b, c then show the pull-out guide with inserted contact elements 3 in two different pull-out positions.

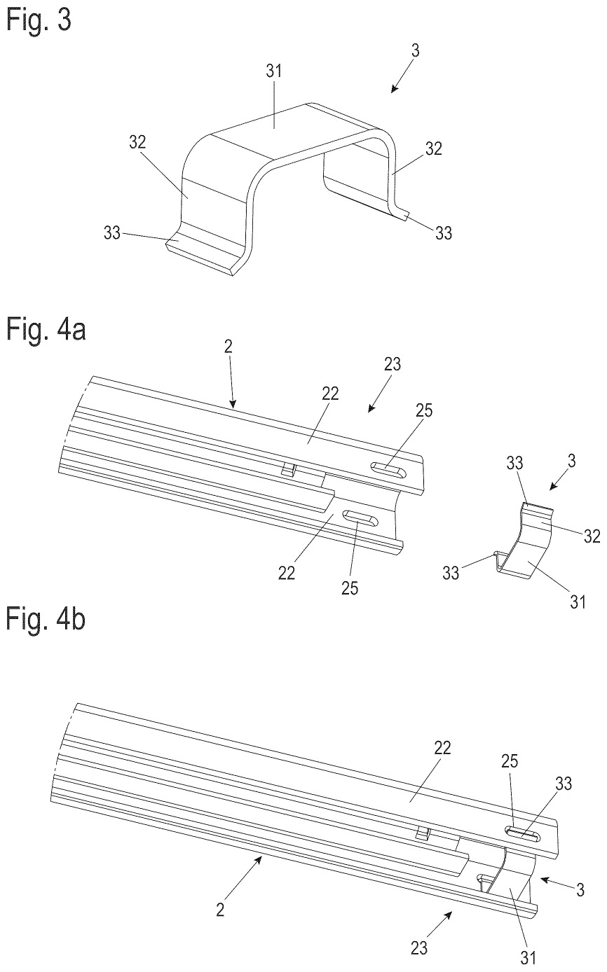

FIG. 3 shows the contact element 3 of the first two exemplary embodiments of the pull-out guides enlarged in a spatial representation. As previously mentioned, it is made of a conductive sheet metal material, preferably stainless steel, but also aluminum, copper or bronze or other metal alloys.

In this example, the contact element 3 is bent in a U-shape with a base 31 and limbs 32. The free ends of the limbs 32 are flared outwards, forming latching tabs 33. When inserted into the body rail 1 or the running rail 2, the latching tabs 33 latch into the corresponding recesses 15 or 25. This ensures a mechanically tight fit on the one hand and an electrically good contact with low contact resistance on the other.

FIGS. 4a, b show a front part of the running rail 2 enlarged again and with a view from diagonally below into the U-shaped profile. In FIG. 4a, the contact element 3 is shown separately before insertion, in FIG. 4b it is inserted into the running rail 2.

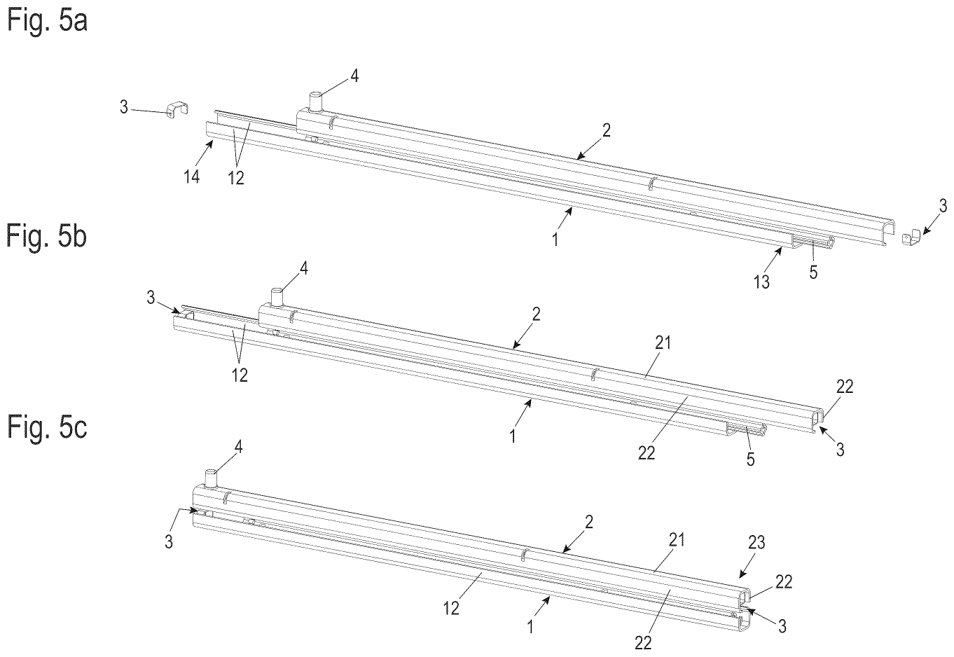

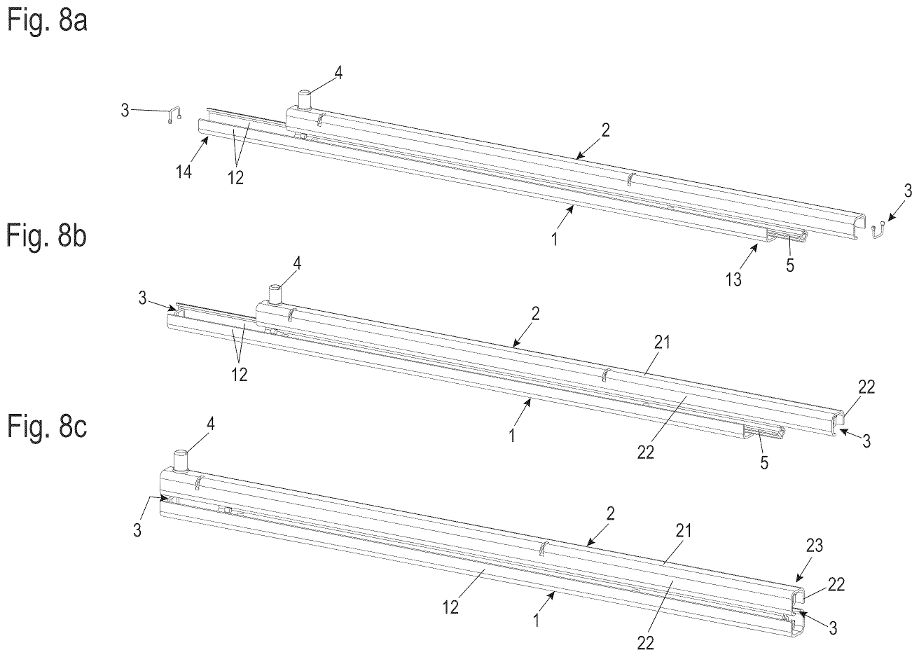

FIGS. 5a-c, 6, and 7a, b and FIGS. 8a-c, 9, and 10a, b show a third and a fourth exemplary embodiment of a pull-out guide according to the application, in each case in the same way as in FIGS. 2a-c, 3, and 4a, b.

In both cases, the basic structure corresponds to that of the second exemplary embodiment. A contact element 3 is also arranged in the front end section 23 of the running rail 2 and a contact element 3 in the rear end section 14 of the body rail 1.

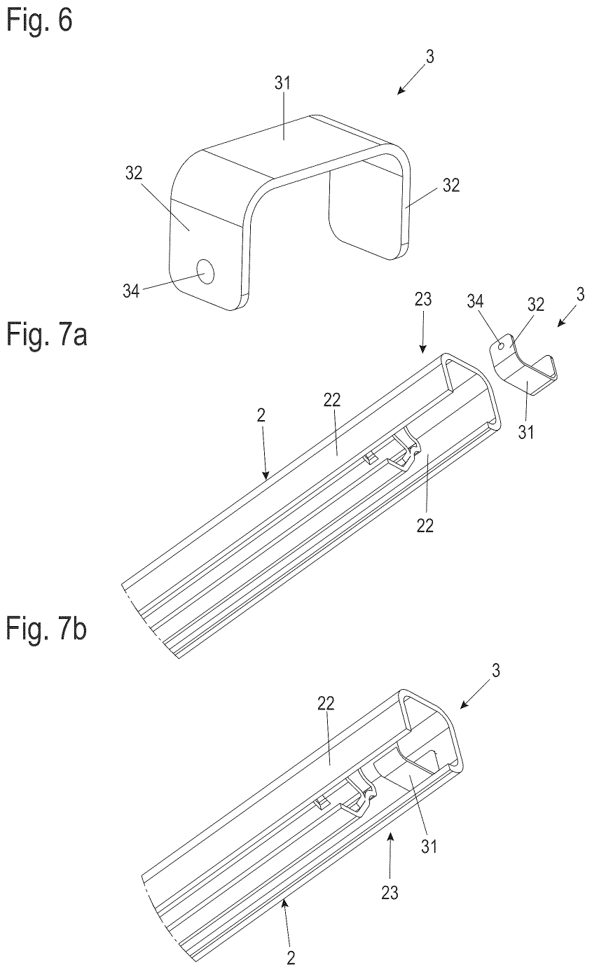

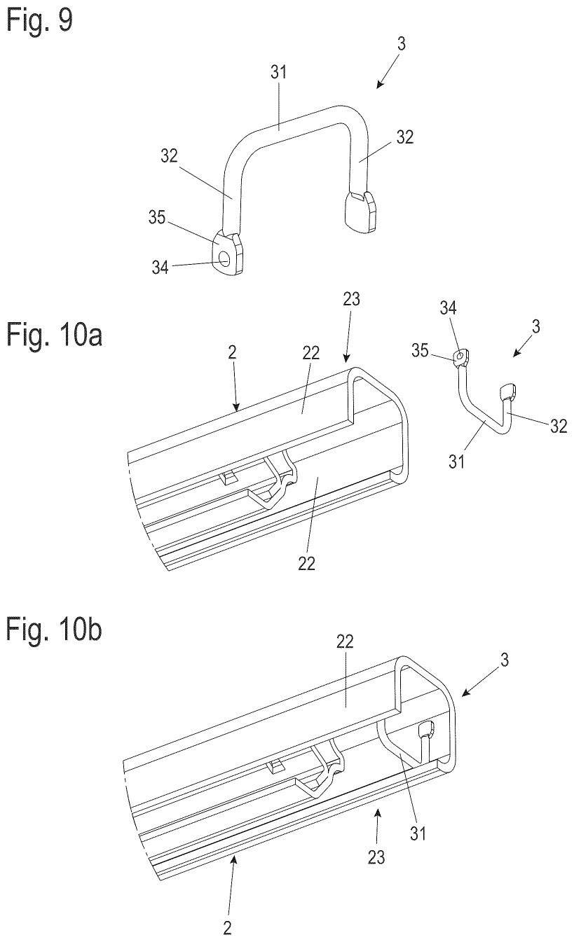

Unlike in the first two exemplary embodiments, the contact elements 3 are not mounted in the rails 1, 2 in a latching manner but are welded on. Preferably, a contact spot welding process is used, as indicated in particular in FIGS. 6 and 9 by the intended position of a welding spot 34.

The contact element 3 of the third exemplary embodiment of FIGS. 5a-c, 6, and 7a, b is comparable to that of the first two exemplary embodiments except for the latching tabs 33, which is a U-shaped bent sheet metal strip.

The contact element 3 of the fourth exemplary embodiment of FIGS. 8a-c, 9, and 10a, b, on the other hand, is a U-shaped bent wire bracket with limbs 32 that have flat areas at their free ends. These flat areas form contact surfaces 35 with which the contact element 3 rests against the limbs 12, 22 of the body rail 1 or the running rail 2. The contact surfaces 35 facilitate the welding process and the intended position of the respective welding point 34 lies correspondingly on the contact surface 35.

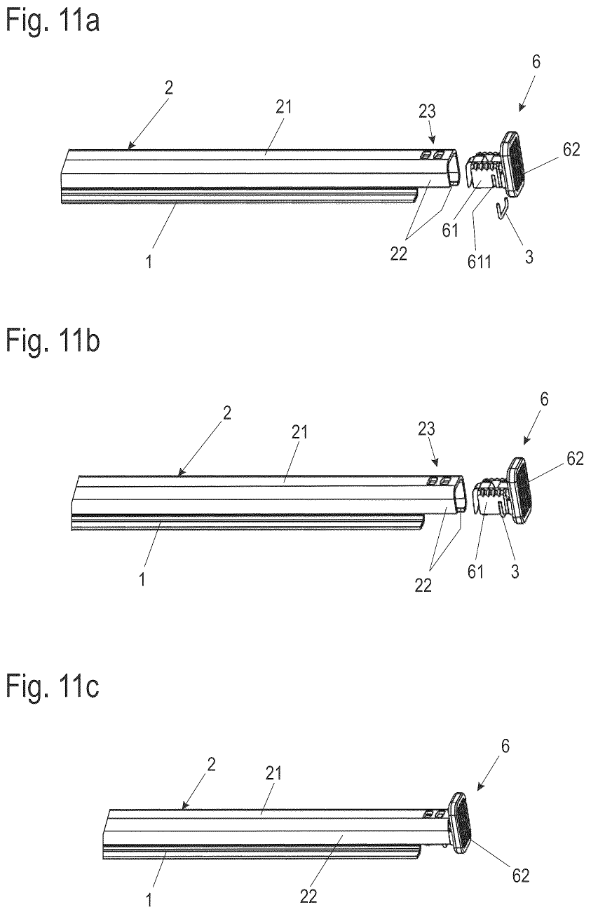

FIGS. 11a to 16c show three further exemplary embodiments of pull-out guides, the basic structure of which corresponds to the pull-out guide of the first exemplary embodiment and has a body rail 1 and a U-shaped running rail 2. Only a front section of each of the pull-out guides is shown.

In all three exemplary embodiments, a plug 6 is inserted into the U-shaped profile of the running rail 2 from the front. For this purpose, the plug 6 has an insertion body 61, which is pushed into the profile of the running rail 2. After the insertion body 61 has been inserted, the plug 6 rests against the front end of the running rail 2 with a contact element 62 projecting laterally and in particular upwards beyond the insertion body 61. The contact element 62 prevents the cooking product carrier from sliding forwards off the running rail 2.

In contrast to the running rail 2, which is made of metal, the plug 6, and in particular the contact element 62, is preferably made of an electrically insulating material, for example the plastic PEEK (polyether ether ketone). As a result, the contact element 62 of the plug 6 separates the metal of the running rail 2 from a door, flap or other front of the microwave oven. This prevents a possible sparkover between the front end of the running rail 2 and the front. Microwave ovens often have a door or flap with a front panel that is provided with conductive elements, for example with a conductive coating or wires in the glass. The material of the contact element 62 or the plug 6 can also be shock-absorbing and/or thermally insulating and thus protect the door or flap mechanically and with regard to local thermal loads.

In the exemplary embodiments shown, the plug 6 is formed as a single piece, for example made of plastic, e.g., the aforementioned PEEK, in an injection molding process. Alternatively, multi-part designs of the plug 6 are also possible.

In the front area of the running rail 2, two recesses are made in the base 21 of the running rail 2, into which, for example, latching elements of the insertion body 61 engage, so that the plug 6 is fixed to the running rail 6 after insertion. However, it is also possible to secure the inserted plug 6 to the running rail 2 by countersinking a web remaining between the two recesses.

According to the application, a contact element 3 is also present in the three exemplary embodiments of FIGS. 11a to 16c, which electrically connects the limbs 22 of the running rail 2 in the front end section 23 at a distance from the base 21. In each case, the contact element 3 is arranged in or on the plug 6.

FIGS. 11a-c and 12a, b show a first exemplary embodiment of such a pull-out rail, in which the plug 6 carries the contact element 3.

FIGS. 11a, b each show a section of the body rail 1 and the running rail 2, as well as the plug 6 before insertion into the front end of the running rail 2. Recesses 611 are made in the insertion body 61 of the plug 6 at the sides and from below, into which the contact element 3 shown separately in FIG. 11a is inserted. In this exemplary embodiment, the contact element 3 is a U-shaped bent wire section.

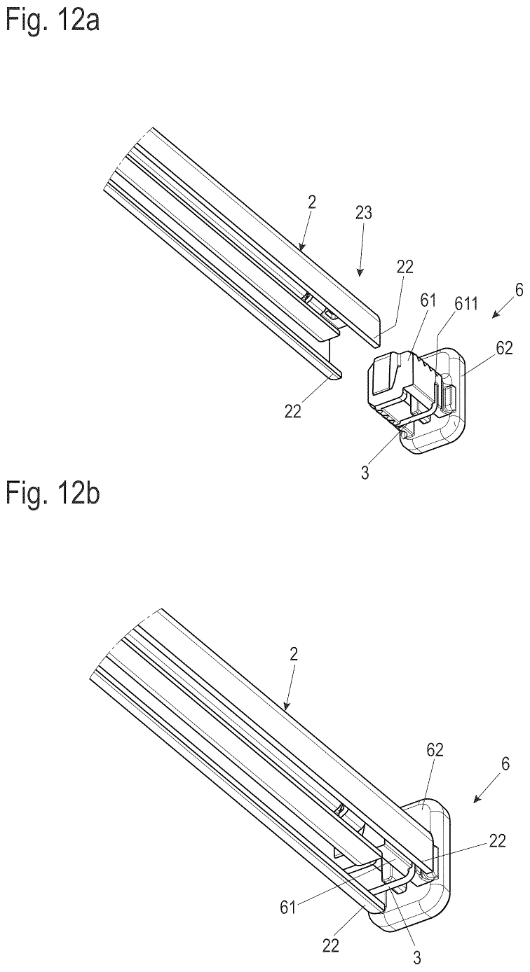

FIGS. 11b and 12a show the contact element 3 inserted into the insertion body 61 from two different angles. Finally, in FIGS. 11c and 12b, the insertion body 61 is inserted into the running rail 2. It can be seen that the contact element 3 connects the limbs 22 of the U-shaped running rail 2 in the area of the front end section 23. In the end area, the profile of the running rail 2 is therefore again electrically closed in a ring shape, which provides effective shielding against microwaves.

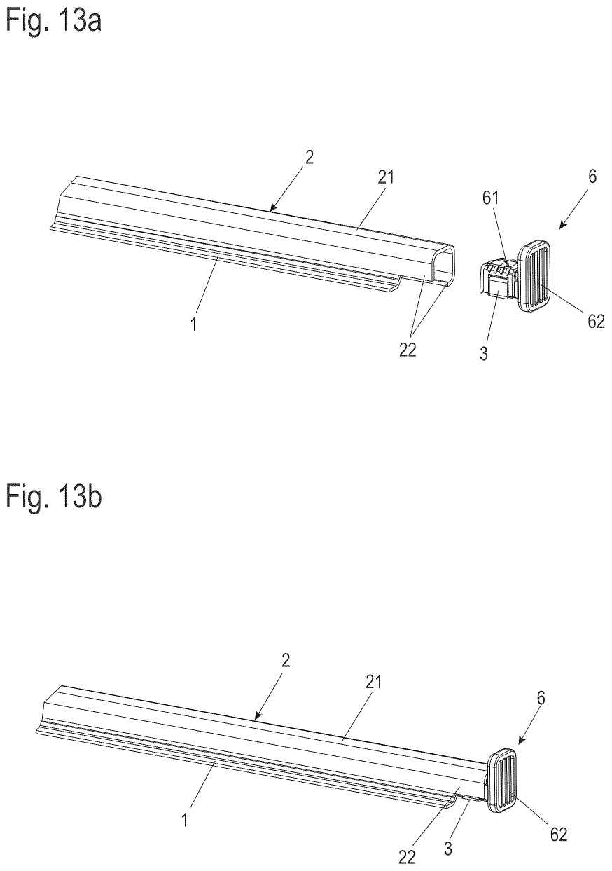

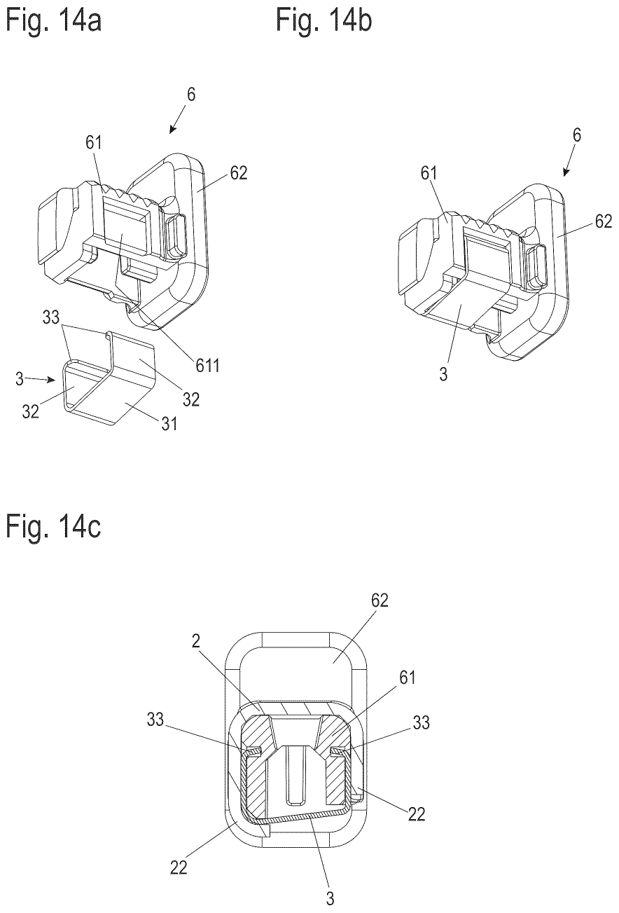

FIGS. 13a, b and 14a-c show a second exemplary embodiment of a pull-out guide with plug 6 and contact element 3. The illustration in FIGS. 13a, b corresponds to that in FIGS. 11b, c. In FIGS. 14a, b, the plug 6 is shown separately in a spatial representation before the contact element 3 is mounted or with the contact element 3 mounted. FIG. 14c shows a sectional view of the running rail 2 with the plug 6 inserted.

In contrast to the previously described exemplary embodiment in FIGS. 11a to 12b, the contact element 3 is a U-shaped bent sheet, not a wire section. Accordingly, the recesses 611 in the insertion body 61 are wider. For a better hold of the contact element 3 on the insertion body 61, inwardly directed latching tabs 33 are formed on the limbs 32, by means of which the contact element 3 is fixed in the recesses 611. In principle, the effect is similar to that of the previously described exemplary embodiment, wherein the greater width of the sheet metal compared to the wire section results in more secure contact between the contact element 3 and the limbs 22 of the running rail 2. Depending on the length of the individual limbs 22 of the U-shaped running rail 2, the contact element 3 can deviate from a symmetrical U-shape, as shown in FIG. 14c, in order to connect the end sections 25 of the limbs by the shortest route.

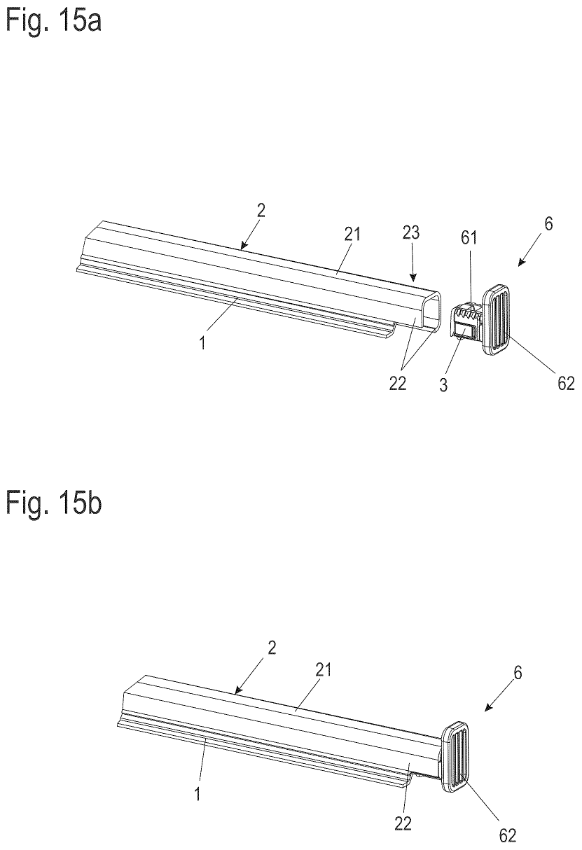

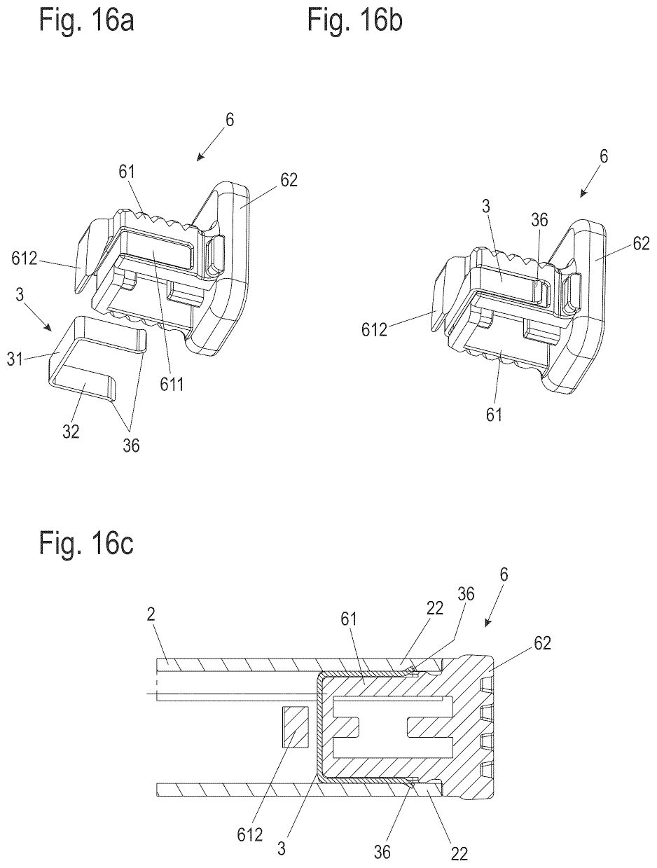

Finally, FIGS. 15a to 16c show a third exemplary embodiment of a pull-out guide with plug 6 and contact element 3 in a similar way to FIGS. 13a to 14c.

Similar to the previous exemplary embodiment, a U-shaped metal sheet is used as contact element 3. In contrast to the previous exemplary embodiment, the limbs 32 of the U-shaped contact element 3 are oriented in the pull-out direction and not perpendicular to it. The recesses 611 on the insertion body 61 are also aligned accordingly.

The advantage here is that even greater clamping forces (which lead to better contact between the contact element 3 and the running rail 2) can be applied without the risk of the contact element 3 being pushed out of the recesses 611 when it is inserted into the running rail 2. In order to achieve a particularly good electrical contact, in this exemplary embodiment the contact element 3 is additionally provided with an angled contact tab 36 at each of its two free ends towards the outside. The contact tabs 36 represent the main contact points to the running rail 2, which are preferably located in the front area of the end section 23. A stop tab 612 integrated in the rear area of the plug 6 prevents the pre-assembled contact element 3 from falling out of the recess 611 during assembly and also prevents other guide elements, such as the body rail 1 or the center rail 5, from making contact with the contact element 3.

The contact elements 3 shown in the exemplary embodiments in FIGS. 11a-16c can also be fixed to the plug 6 by other means in a material, form-fitting or force-fitting manner or can already be manufactured in a common manufacturing process, e.g. as an insert part or in 2-component injection molding.

The contact elements 3 described in the exemplary embodiments do not necessarily have to have the same design for the body rail 1 and the running rail 2 of a pull-out guide and or be attached using the same method, but can also be combined with one another. For example, the heat development in the pull-out guide can be optimized by a coordinated selection of the contact elements 3 or the additional process step can be adapted to the manufacturing process of the pull-out guide.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Body rail
11 Base
12 Limb
13 Front end section
14 Rear end section
15 Recess
2 Running rail
21 Base
22 Limb
23 Front end section
24 Rear end section
25 Recess
3 Contact element
31 Base
32 Limb
33 Latching tab
34 Spot weld
35 Contact surface
36 Contact tab
4 Stop
5 Center rail
6 Plug
61 Insertion body
611 Recess
612 Stop tab
62 Contact element

1-15. (canceled)

16. A pull-out guide for a domestic appliance with microwave cooking function, the pull-out guide comprising:
a body rail;
at least one running rail moveable relative to the body rail and configured so that a cooking product carrier is arrangeable on the at least one running rail for the microwave cooking function, wherein the body rail or the running rail have a U-shaped profile with a base and first and second limbs; and
a contact element electrically connecting the first and second limbs to each other in in an end region of the body rail or the running rail, wherein the contact element is arranged at a distance from the base.

17. The pull-out guide of claim 16, wherein the body rail or the running rail is made of metal.

18. The pull-out guide of claim 16, wherein the contact element is made of a metal sheet or wire.

19. The pull-out guide of claim 16, wherein the contact element is U-shaped and has a base and two lateral limbs.

20. The pull-out guide of claim 19, wherein the two lateral limbs of the contact element contact the first and second limbs of the body rail or the running rail.

21. The pull-out guide of claim 16, wherein the contact element contacts inner sides of the first and second limbs.

22. The pull-out guide of claim 19, wherein the first and second limbs of the body rail or the running rail include recesses configured so that the contact element engages in the recesses in a latching manner.

23. The pull-out guide of claim 22, wherein the contact element has outwardly projecting latching tabs at free ends of the two lateral limbs of the contact element, wherein the outwardly projecting latching tabs engage in the recesses.

24. The pull-out guide of claim 16, wherein the contact element is welded to the first and second limbs of the body rail or the running rail.

25. The pull-out guide of claim 16, further comprising:
a plug inserted into a front end of the running rail or into a rear end of the body rail, wherein the contact element is arranged on or in the plug.

26. The pull-out guide of claim 25, wherein the plug has an insertion body fastened to the running rail or the body rail in a clamping or latching manner, wherein the contact element is arranged on or at least partially in the insertion body.

27. The pull-out guide of claim 26, wherein the insertion body of the plug has at least one recess at least partially accommodating the contact element.

28. The pull-out guide of claim 26, wherein the plug is made of an insulating material.

29. The pull-out guide of claim 26, wherein the plug is made of a thermally insulating or shock-absorbing material.

30. A domestic appliance comprising:
body; and
a pull-out guide arranged in the body, wherein the pull-out guide comprises
a body rail;
at least one running rail moveable relative to the body rail and configured so that a cooking product carrier is arrangeable on the at least one running rail, wherein the body rail or the running rail have a U-shaped profile with a base and first and second limbs; and
a contact element electrically connecting the first and second limbs to each other in in an end region of the body rail or the running rail, wherein the contact element is arranged at a distance from the base,
wherein the domestic appliance includes a microwave cooking function.
